(19) United States
(12) Patent Application Publication
(10) Pub. No.: US 2007/0216517 A1
(43) Pub. Date: Sep. 20, 2007

(54) Automatic vehicle door locking with seat occupant sensor

(75) Inventors: Christopher M. Kurpinski, Berkley, MI (US); Keiichi Aoyama, Anjo-shi (JP); Justin P. McBride, Bloomfield, MI (US); Thomas J. Keeling, Plymouth, MI (US); Michael A. Wiegand, Birmingam, MI (US); Tanemichi Chiba, Novi, MI (US)

Correspondence Address: HARNESS, DICKEY & PIERCE, P.L.C., P.O. BOX 828, BLOOMFIELD HILLS, MI, 48303, US

(73) Assignee: DENSO International America, Inc.

(21) Appl. No.: 11/375,672

(22) Filed: Mar. 14, 2006

(51) Int. Cl. G05B 19/00; B60R 25/00; G05B 23/00

(52) U.S. Cl. 340/5.72; 340/5.61; 340/825.49

(57) ABSTRACT

A vehicle door automatic locking apparatus and method utilizes an electronic control unit, an occupant sensor or a seat with an occupant sensor, a vehicle door, and a vehicle door lock, wherein when the vehicle door is closed and the sensor does not sense seat occupation, the vehicle door lock locks the vehicle door. Additionally, a timer may be employed to lock the door locks after a timeout period. Furthermore, an electronic key fob and an antenna in communication with the electronic control unit and the key fob may be utilized such that when the electronic control unit via the antenna verifies that the key fob is outside of the vehicle, vehicle door locking occurs. Alternatively, if the electronic control unit via the antenna verifies that any key fob is within the vehicle, then automatic locking will not occur and user notification occurs.

### FIELD

The present disclosure relates to an apparatus and method of automatically locking a vehicle door while utilizing a seat occupant sensor.

### BACKGROUND

The statements in this section merely provide background information related to the present disclosure and may not constitute prior art. Present passive entry vehicle systems require the exiting user to pause to lock a door, such as the driver's door, upon exiting a vehicle. This pause may consist of a user having to look for a button on the vehicle door handle on the exterior of the vehicle door. This pause is an inconvenience to the vehicle user and wastes his or her time. Additionally, when mechanical means, such as a button, are used to lock a door, additional mechanical parts within the door are required. These component parts add cost to the overall price of a vehicle. Additionally, these parts contribute to assembly times, costs and the complexity of the interior of the door.

Although locking a vehicle door by pressing a button ensures that the vehicle will be locked, if a user forgets to turn around and press a door handle button upon exiting, the vehicle will normally remain unlocked. This puts the vehicle, vehicle components, and vehicle interior contents at the risk of being stolen.

What is needed then is an apparatus and method of effortlessly and transparently locking a vehicle door upon a user exiting the vehicle, such as through non-contact locking methods.

### SUMMARY

In accordance with teachings of the invention, a vehicle door lock control apparatus utilizes an electronic control unit, an occupant seat, a sensor to sense occupation and non-occupation of the seat, the sensor being in communication with the electronic control unit regarding the occupation and the non-occupation of the seat. Additionally, a vehicle door and a vehicle door lock work in conjunction with the electronic control unit such that when the vehicle door is closed and the sensor does not sense occupation of the seat, the vehicle door lock may lock the vehicle door, such as after a timeout period.

The vehicle door lock control apparatus may utilize an electronic key fob, as a transceiver, and at least one antenna in communication with the electronic control unit and the key fob, wherein the antenna verifies that the key fob is physically outside of the vehicle before locking the vehicle door lock, also possibly after a timeout period or immediately upon verification. Alternatively, if the antenna verifies that a valid key fob is inside of the vehicle, the electronic control unit may maintain the vehicle door in an unlocked state. Although one door is being used to describe operations of the system, more than one door may be used and such locking functions may be simultaneously performed on more than one door.

A time period and timer have been described that may be used in conjunction with automatically locking the vehicle door. Such a timer may be used such that upon expiration of an amount of time of the timer, the vehicle door locks will automatically lock. This may be performed after the electronic control unit verifies that no key is inside the vehicle.

The seat sensor within the seat may function based on the weight of an occupant such that the sensor is normally activated when an occupant sits on the seat. Alternatively the occupant sensor may be outside of the seat and sense an occupant by infra-red technology or optical technology, such as with a light sensitive sensor.

A method of controlling a door lock of a vehicle may entail determining that the vehicle ignition is off and that a vehicle door is not closed (e.g. open), determining that the vehicle door is closed and not locked, and verifying that an occupant sensor does not sense an occupant, and then locking the vehicle door lock. Again, although one vehicle door and door lock is described, more than one door and door lock may be controlled. Furthermore, after verifying that a seat sensor corresponding to a door is not active, such method may entail starting a timing of a fixed timeout period, inquiring whether the fixed timeout period has been reached, scanning an area exterior to the vehicle for a first electronic key fob, scanning an area interior to the vehicle for a second electronic key fob and ultimately locking the vehicle door lock. Upon locking any vehicle doors, an audible and/or visual signal may be delivered from the vehicle or fob to the user.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a top view of a vehicle depicting locations of antennas, a sensor, and an ECU;

FIG. 2 is flowchart of a method of locking a vehicle door;

FIG. 3 is a top view of a vehicle depicting a user approaching the vehicle;

FIG. 4 is a top view of a vehicle depicting a user walking away from the vehicle;

FIG. 5 is a top view of a vehicle depicting a user outside of a communication range of a vehicle system;

FIG. 6 is a top view of a vehicle depicting a driver approaching the vehicle while a passenger walks away from the vehicle; and

FIG. 7 is a top view of a vehicle depicting a user who is at a specific distance from the vehicle at which distance specific vehicular functions occur.

### DETAILED DESCRIPTION

The following description is merely exemplary in nature and is not intended to limit the present disclosure, application, or uses. It should be understood that throughout the drawings, corresponding reference numerals indicate like or corresponding parts and features.

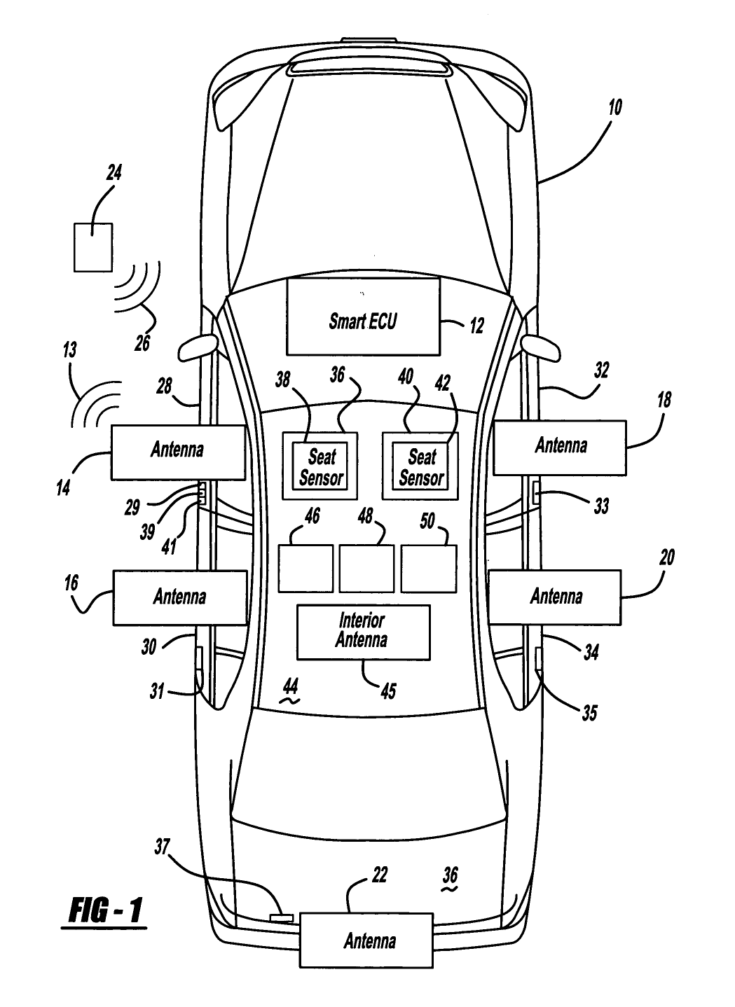

FIG. 1 is a top view of a vehicle 10 depicting various locations of antennas, sensors, and a Smart ECU. More specifically, a vehicle 10, such as an automobile, may employ a Smart ECU 12, which is used in conjunction with various antennas, such as a driver side front door antenna 14, a driver side rear door antenna 16, a passenger side front door antenna 18, a passenger side rear door antenna 20, a trunk area antenna 22, and interior antenna 45. The Smart ECU 12 is used in conjunction with the antennas 14, 16, 18, 20 to place particular vehicle doors into an unlock standby mode prior to unlocking by a user 52, as explained below. The interior antenna 45 is used to check for any key fobs that may be left in the interior of the vehicle during a locking routine, to be described later. The Smart ECU is referred to as “smart” because of its intelligent function of knowing when to unlock vehicle doors without the use of a traditional, physical metal key.

With continued reference to FIG. 1, one type of “smart key” entry system, such as a polling system for example, permits a vehicle user to approach a vehicle 10 with a key fob 24 which, based upon proximity of the key fob 24 to an antenna 14, 16, 18, and 20, places a respective door, such as a driver side front door 28, a driver side rear door 30, a passenger side front door 32, or a passenger side rear door 34, or other vehicle access point, such as a trunk 36 utilizing antenna 22, respectively, into an unlock standby mode. The door unlock standby mode is achieved without human manipulation of any buttons on the key fob 24. To accomplish automatic door unlocking, the user must simply possess a “smart key” fob 24, also known as a transponder or electronic key. The electronic key emits a frequency response 26 to at least one of antennas 14, 16, 18, 20, and 22 when the user walks within a specific radio frequency communication range of such antennas of the vehicle 10. Subsequent to such communication, when the user then, for example, touches a sensor 41 of a door handle 39 of a door 28, 30, 32, 34, 36, that respective door lock 29 will unlock. The user may then pull on the specific door handle to complete opening of the door 28 to gain access.

More specifically, with continued reference to FIG. 1, the vehicle 10 possesses a variety of electronic control units, (“ECUs”), one of which is a Smart ECU 12 that communicates with the key fob 24 to place the door locks in an unlock standby mode. Unlocking of the vehicle door locks is accomplished in a subsequent process. In a traditional smart key system, before a user approaches the vehicle 10, that is, when a user is outside of the communication range of the smart ECU 12, the smart ECU 12 causes a specific radio frequency signal 13 to be emitted in a polling fashion from the various antennas 14, 16, 18, 20, 22 located within and about the vehicle 10. The signal is pulsed at a specific time interval and may be pulsed in a polling fashion taking into consideration all of the on-board antennas. The communication radius may be three or four feet (about 1-1.5 meters) as an example, but may be determined by the manufacturer.

Next, when the transponder 24 is within the communication radius of an antenna 14, 16, 18, 20, the fob 24 may transmit a unique security code to the smart ECU 12, and when the smart ECU 12 recognizes the unique security code, the door locks 29, 31, 33, 35, 37 of the vehicle 10 are placed into unlock standby mode. In the case of FIG. 1, the front driver side lock 29 will be placed into a condition of unlock standby when the transponder 24 is within the communication zone radius of door antenna 14. When in unlock standby mode, the door handle 39 may be touched on a rear side to activate a contact sensor 41.

FIG. 1 also depicts a driver seat 36, which possesses a driver seat sensor 38, and a front passenger seat 40, which possesses a front passenger seat sensor 42. The vehicle interior 44 also possesses an interior antenna 45. The operative workings of the sensors and antennas will now be explained by referring to FIGS. 1 and 3-7.

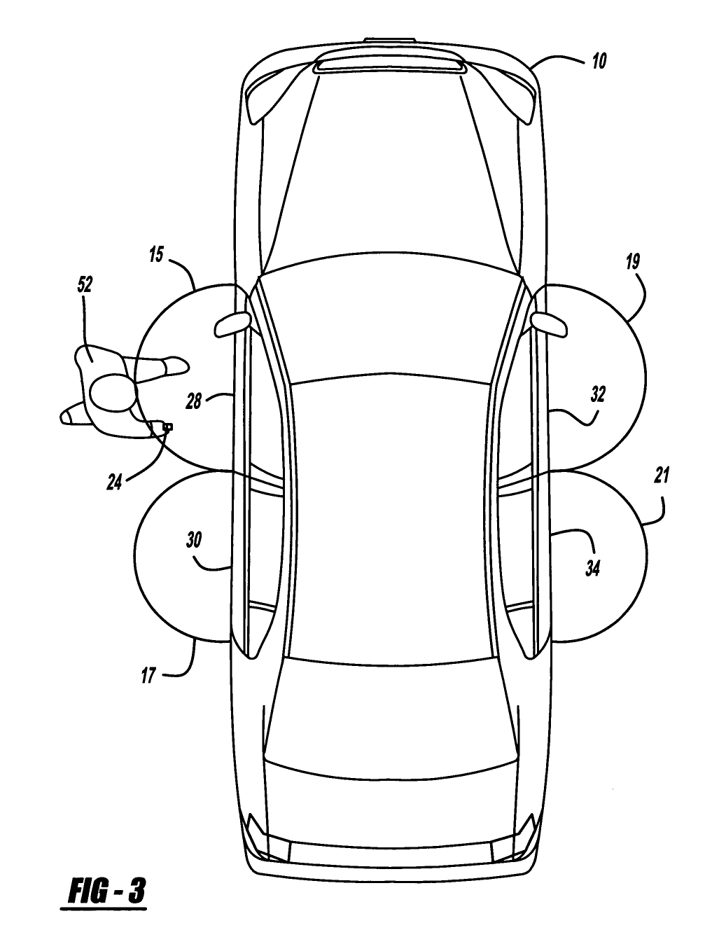

FIGS. 1 and 3-5 depict a first scenario for locking the door locks 29, 31, 33, 35, 37 of a vehicle 10. FIG. 3 depicts a user 52, holding a smart key type of key fob 24, who has just exited the vehicle 10 and who has closed all vehicle doors 28, 30, 32, 34. As depicted, although the user 52 has exited the vehicle 10, the user 52 remains standing within the transmitting range of antenna 14, which may be located within door 28. This means that the key fob 24 of the user 52 is communicating with the polling signal 13 of the antenna 14, which is governed by the Smart ECU 12. With the user 52 in this position, because the key fob 24 and Smart ECU 12 are able to communicate, the doors 28, 30, 32, 34 have not locked.

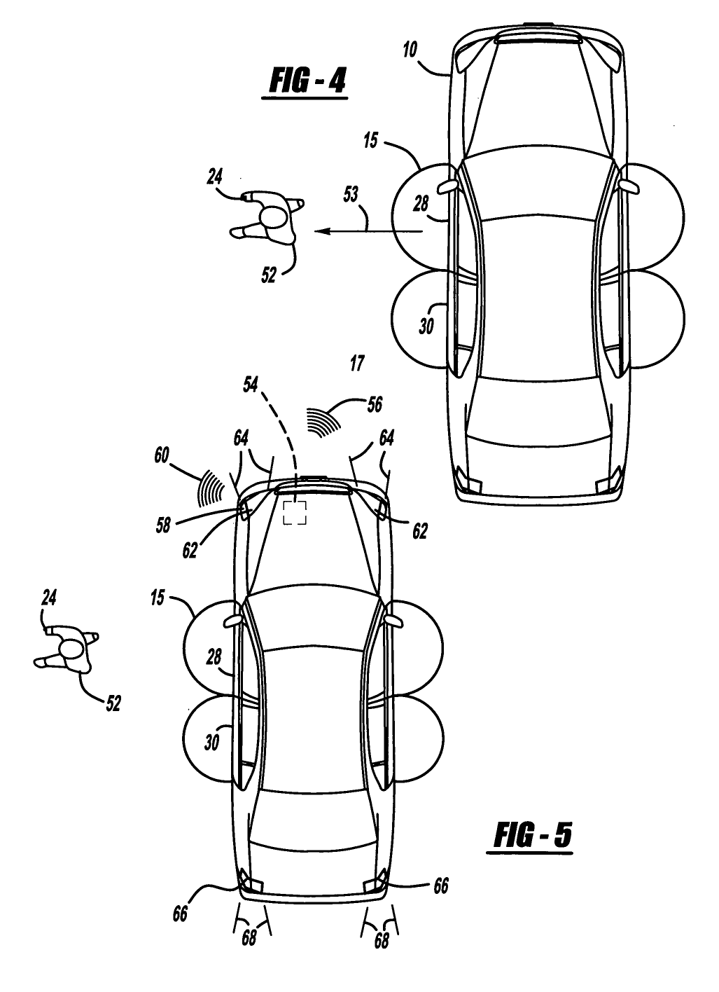

FIG. 4 depicts the user walking away from the vehicle 10 according to direction arrow 53 such that the user 52 becomes out of the range 15 or zone of the polling signal 13 transmitted by antenna 14 of door 28. When the user 52 walks out of the range 15, the locks 29, 31, 33, 35 of the vehicle doors 28, 30, 32, 34 lock. FIG. 5 denotes the locking event, which will now be described.

FIG. 5 depicts the user 52 with key fob 24 outside of the zone 15. Immediately after the user 52 with key fob 24 is outside of the zone 15, the Smart ECU 12 verifies that the user 52 is not in the driver seat 36 by verifying that the driver seat sensor 38 is not activated. The driver seat sensor 38 may be any of various kinds of sensors, such as a weight sensor or contact sensor. When weight is placed on the driver seat 36, the seat sensor 38 is activated, which means that, for example, electrical switch contacts become closed. Upon both of these events, that is, the key fob 24 being outside of the zone 15, and the driver seat sensor 38 being not activated, the door locks 29, 31, 33, 35 of the doors 28, 30, 32, 34 will lock. Although the seat sensor 38 has been described as a weight sensor, the invention is not limited to such and a non-contact sensor such as an infra-red sensor or light-sensing optical sensor may be used. Such an infra-red sensor may be dash or ceiling mounted and directed to where an occupant might sit. An optical sensor may be flush-mounted in the seatback or seat bottom and sense light from an occupant.

Upon all door locks 29, 31, 33, 35 locking, notification to the user 52 of such locking may occur. Notification may take the form of a horn 54 that makes sound waves 56, at least one turn signal 58 that flashes light 60, at least one headlight 62 that flashes light 64, or at least one taillight 66 that flashes light 68, or any combination of such forms of locking notification.

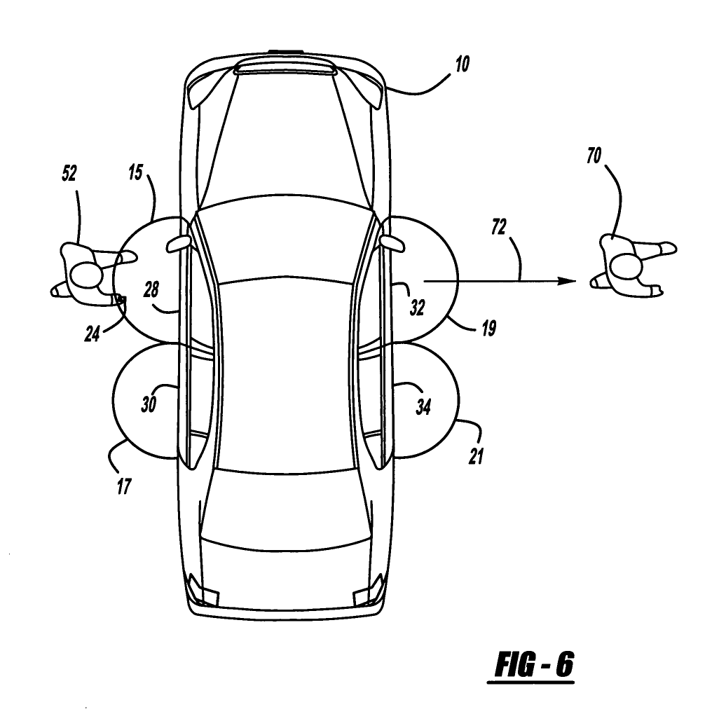

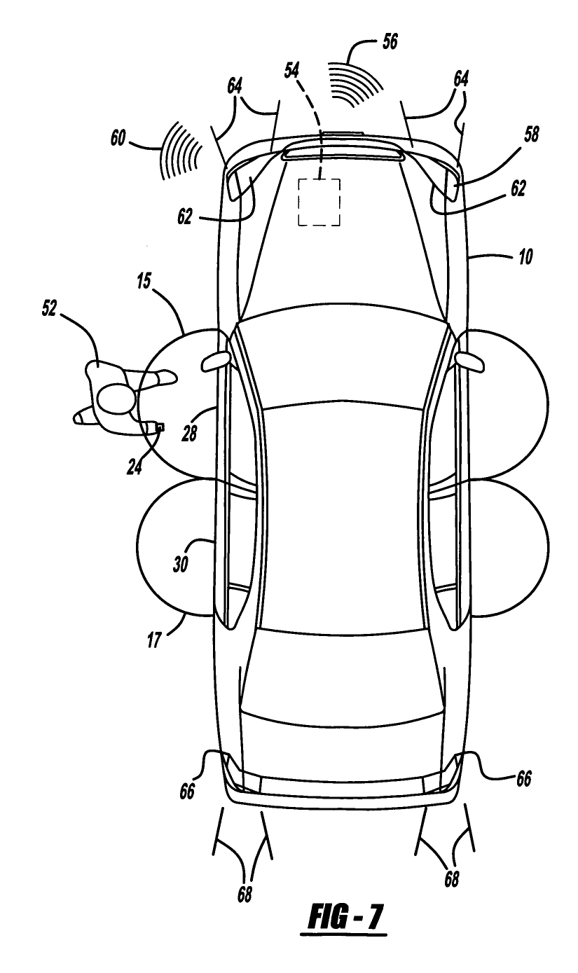

FIGS. 6 and 7 depict yet another scenario for automatically locking the doors 28, 30, 32, 34. When the user 52 exits the vehicle 10 and stands within the communication zone 15 of the antenna 14 of the front door 28, thereby intercepting the pulsing signal from antenna 14, the system checks to ensure that the driver seat sensor 38 within the driver seat 36 is no longer activated by the weight, for example, of the user 52. When both of these conditions are met, then a timer begins. After a predetermined time period, such as 15, 30 or 60 seconds, as examples, the door locks 29, 31, 33, 35 will automatically lock. Such automatic door locking by the Smart ECU 12 occurs after a timeout period, even though the key fob 24 is within the communication zone of the antenna 14. Automatic door locking after a timeout period may be invoked in order to conserve electricity or protect the contents of the vehicle 10, even when a user 52 may be relatively close to the vehicle 10. Electricity from the vehicle battery is normally used by the Smart ECU 12 and antennas while polling for the key fob 24. Although the description above utilizes communication zone 15, another zone, such as communication zone 19 may be used.

FIG. 7 depicts notification to the user 52, who is standing within the polling zone 15, that automatic door locking has occurred due to timeout. Again, notification may take the form of a horn 54 that makes sound waves 56, at least one turn signal 58 that flashes light 60, at least one headlight 62 that flashes light 64, or at least one taillight 66 that flashes light 68, or any combination of such forms of notification.

In a related scenario, and with continued reference to FIG. 6, a front passenger 70 may cause the door locks 29, 31, 33, 35 to automatically lock. In effectuating such locking, the driver 52 may exit and walk away from the vehicle 10 in accordance with direction arrow 72, while the front passenger 70 remains in the vehicle 10. In this situation, although the Smart ECU 12 recognizes that the driver 52 has exited the driver seat 36 because the driver seat sensor 38 is no longer activated, and that the driver may or may have not left the polling area 15 of the front door antenna 14, the doors will not yet lock because the front passenger 70 remains in the vehicle 10 and continues to activate the passenger seat sensor 42 within the passenger seat 40. However, as depicted in FIG. 6, if the front passenger 70 chooses to exit the vehicle 10, then as soon as the front passenger 70 stops activating the front passenger seat sensor 42 of the front passenger seat 40 and all doors are closed, a timer begins and the Smart ECU 12 will automatically lock the door locks 29, 31, 33, 35 of the doors 28, 30, 32, 34 at the end of the timeout period.

Another feature of the automatic locking system is that the Smart ECU 12, in conjunction with interior antenna 45 located within the vehicle interior 44, performs an interior check for key fobs before automatic vehicle door locking to determine if any additional key fobs are inside the vehicle 10. For instance, in the event a user 52 exits and walks away from the vehicle 10 with key fob 24, as depicted in FIG. 3, the Smart ECU 12 will then poll the vehicle interior 44 using interior antenna 45 to determine if any additional key fobs remain within the vehicle interior 44. In the event that any additional key fobs are detected, the Smart ECU 12 will cause notification or an alarm to sound to alert the user 52 that at least one an additional key fob remains within the vehicle 10. Such notification will occur before the user leaves the immediate area of the vehicle 10. The alarm may consist of sound waves 56 from the vehicle horn 54 or from light being emitted from the headlights 62, turn signals 58, taillights 66 or a combination of such. Alternatively, the fob that the user is carrying may sound an alarm or vibrate to alert the user 52 of the additional key fob within the vehicle interior 44.

A vehicle locking system has been described in which a user 52, such as a vehicle driver, possesses a key fob 24 that is either within or outside of a polling zone 15 of antenna 14 of the front door 28; however, the key fob 24 and Smart ECU 12 may work in conjunction with every antenna polling zone. For instance, if the key fob 24 depicted in FIG. 3 is within polling zone 21 of antenna 20 of passenger rear door 34, and then passes outside of such polling zone, then the Smart ECU 12 will perform an autolock upon all locks 29, 31, 33, 35 of doors 28, 30, 32, 34. Likewise, if the user 52 depicted in FIG. 6 stands within polling zone 17 of the driver rear door 30 long enough for the Smart ECU 12 to experience a timeout period, then the Smart ECU 12 will perform automatic locking of all doors 28, 30, 32, 34.

Although a seat sensor is depicted in each of the driver seat 36 and the front passenger seat 40, the invention is not limited to such. For instance, each of the left rear seat 46, center rear seat 48, and right rear seat 50 may have a seat sensor. In such a case, the above-described operations involving the driver seat 36 and front passenger seat 40, would operate in a similar fashion.

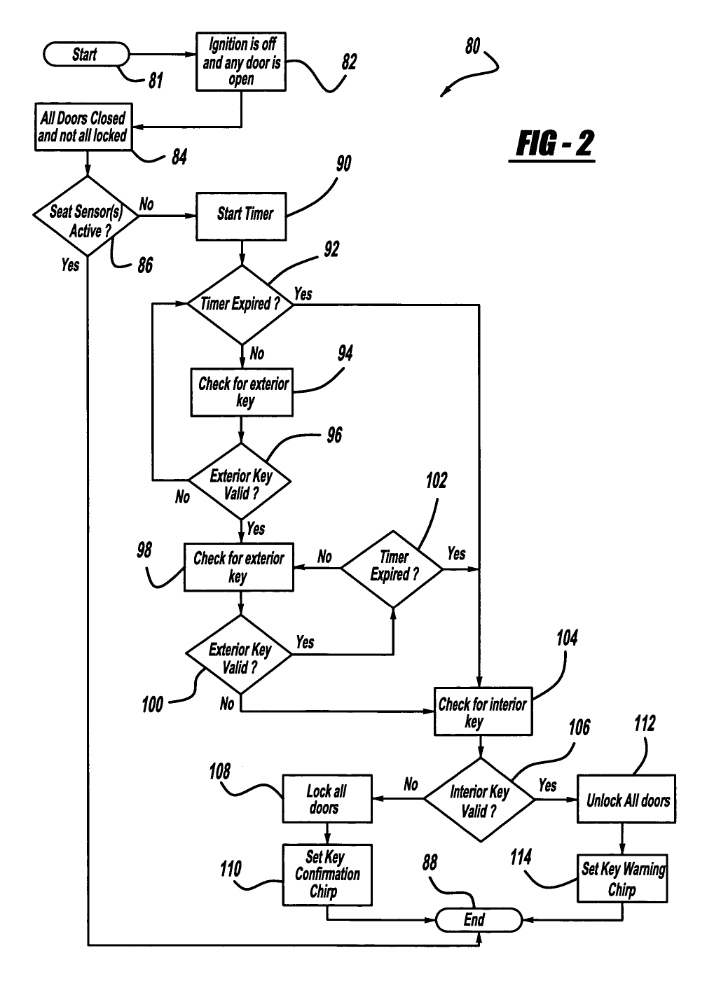

FIG. 2 is a flowchart of a timeout locking routine 80 that depicts control of a timeout and locking routine of vehicle door locks 29, 31, 33, 35. In such a routine 80, from start at step 81, the flow proceeds to step 82, where the logic routine determines if the ignition is off and if any vehicle door is open. When the ignition is off and any vehicle door is open, the Smart ECU 12 anticipates that a vehicle occupant is preparing to exit the vehicle 10 and the routine 80 continues. At any point, when the routine determines that a door is being opened and the vehicle ignition is “on,” the routine 80 returns to step 81 and immediately proceeds to step 82.

When the conditions of step 82 are met, then the flow logic proceeds to step 84, where the Smart ECU 12 determines if all vehicle doors are closed, but not all doors are locked. When the conditions of step 84 are met, the flow logic proceeds to step 86 where a determination is made as to whether any seat sensors are active. The seat sensor include seat sensor 38 in the driver's seat, seat sensor 42 in the front passenger seat 40 and any seat sensor in any of the rear passenger seats 46, 48, and 50. If any seat sensors are active, then the flow logic proceeds to step 88, end, where the flow logic ends. The routine may then begin again at start 81. However, if no seat sensors are active, then the flow logic proceeds to step 90, where a timer begins. The timer may be set for 15, 30, 60 or any period of time.

After the timer begins, the flow logic proceeds to step 92 at which an inquiry is made as to whether the time has expired. If a timeout has occurred, then the flow logic proceeds to step 104 where a check for additional interior key fobs is conducted. If a timeout has not occurred, then the flow logic continues to step 94, where a check for exterior key fobs is conducted. In checking for exterior key fobs, the Smart ECU 12 polls through the antennas 14, 16, 18 and 20. As an example, signal 13 is emitted from antenna 14 toward fob 24 (FIG. 1). Fob 24 responds with signal 26 if fob 24 is within range of signal 13; however, if fob 24 is out of range, then no communication is established between the fob 24 and Smart ECU 12. At step 96, the logic determines if the exterior key is valid. If the key fob is not valid, then the flow logic returns to step 92. If the exterior key is valid, that is found or located, then the flow logic proceeds to step 98 where a check for an exterior key is performed.

Upon checking for the exterior key, the flow logic proceeds to step 100, where an inquiry is made as to whether the exterior key is valid (found). If the exterior key is valid, then the flow logic proceed to step 102, where the smart ECU 12 determines if the timeout period has been reached. If the timeout period has not been reached, then the flow returns to step 98. However, if the timeout period has been reached, then the flow proceed to step 104, where a check for an interior key is performed.

From step 100, if the inquiry into the validity of the exterior key is negative, then the flow proceeds to step 104, where inquiry is made as to the presence of an interior key. The flow logic proceeds to step 106 regardless of whether a key is detected at step 104; however, upon detecting an additional interior key at step 104, the flow logic proceeds to step 106 where an inquiry is made as to whether the interior key is valid. If the interior key is found to be not valid, then the flow logic proceeds to step 108 where all vehicle door locks 29, 31, 33, 35 are locked. Upon locking of all vehicle door locks, a confirmation chirp occurs at step 110. The confirmation chirp is an audible signal that indicates door locking to the driver. The flow will then proceed to step 88, where the routine ends.

At step 106, if the interior key is found and validated, then the flow logic proceeds to step 112 and all doors are unlocked. The routine will not lock the doors with a valid key in the interior of the vehicle, as long as the interior key is detectable by the interior antenna. The flow logic then proceeds to step 114 where a warning chirp occurs. The routine 80 then ends at step 88.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A vehicle door lock control apparatus comprising:
an electronic control unit;
a sensor to sense vehicle occupation and communicate such to said electronic control unit;
a vehicle door lock that communicates its status with said electronic control unit; and
an electronic key fob, wherein said electronic control unit invokes locking of said vehicle door lock when said sensor does not sense vehicle occupation and said electronic key fob is not detected inside of said vehicle by said electronic control unit.

2. The vehicle door lock control apparatus of claim 1, further comprising:
an antenna in communication with said electronic control unit and said key fob, wherein said antenna verifies that said key fob is outside of said vehicle and invokes a locked state of said vehicle door lock.

3. The vehicle door lock control apparatus of claim 1, further comprising:
an antenna in communication with said electronic control unit and said key fob, wherein said antenna verifies that said key fob is inside of said vehicle and maintains said vehicle door lock in an unlocked state.

4. The vehicle door lock control apparatus of claim 1, further comprising:
a timer, wherein upon expiration of an amount of time of said timer, said electronic vehicle door lock invokes a locked state of said vehicle door lock.

5. The vehicle door lock control apparatus of claim 1, wherein said sensor is within said seat.

6. The vehicle door lock control apparatus of claim 1, wherein said sensor functions with weight.

7. The vehicle door lock control apparatus of claim 1, wherein said sensor is outside of said seat.

8. A vehicle door lock control apparatus, comprising:
an electronic control unit;
an occupant seat;
a sensor to sense occupation and non-occupation of said seat, said sensor in communication with said electronic control unit regarding said occupation and said non-occupation of said seat;
a vehicle door; and
a vehicle door lock of said vehicle door, wherein when said vehicle door is closed and said sensor does not sense occupation of said seat, said vehicle door lock locks said vehicle door.

9. The vehicle door lock control apparatus of claim 8, further comprising:
a key fob; and
an antenna in communication with said electronic control unit and said key fob, wherein said antenna verifies that said key fob is not inside said vehicle before locking said vehicle door lock.

10. The vehicle door lock control apparatus of claim 8, further comprising:
a key fob; and
an antenna in communication with said electronic control unit and said key fob, wherein said antenna verifies if said key fob is inside of said vehicle and maintains said vehicle door in an unlocked state.

11. The vehicle door lock control apparatus of claim 8, further comprising:
a timer, wherein upon expiration of an amount of time of said timer, said vehicle door lock locks.

12. The vehicle door lock control apparatus of claim 8, wherein said sensor is within said seat.

13. The vehicle door lock control apparatus of claim 8, wherein said sensor functions with weight.

14. The vehicle door lock control apparatus of claim 8, wherein said sensor is outside of said seat.

15. A method of controlling a door lock of a vehicle, comprising:
determining that an ignition is off and that a vehicle door is not closed;
determining that said vehicle door is closed and not locked; and
verifying that an occupant sensor does not sense a vehicle occupant.

16. The method of claim 15, further comprising:
locking said vehicle door lock.

17. The method of claim 15, further comprising:
starting timing of a fixed timeout period;
inquiring whether said fixed timeout period has been reached; and
locking said vehicle door lock.

18. The method of claim 15, further comprising:
starting timing of a fixed timeout period;
inquiring whether said fixed timeout period has been reached;
scanning an area exterior to the vehicle for a first electronic key fob; and
locking said vehicle door lock.

19. The method of claim 15, further comprising:
starting timing of a fixed timeout period;
inquiring whether said fixed timeout period has been reached;
scanning an area exterior to the vehicle for a first electronic key fob;
scanning an area interior to the vehicle for a second electronic key fob; and
locking said vehicle door lock.
